(19) United States
(12) Patent Application Publication
(10) Pub. No.: US 2015/0260545 A1
(43) Pub. Date: Sep. 17, 2015

(54) GYROSCOPE CALIBRATION

(71) Applicant: Google Inc., Mountain View, CA (US)

(72) Inventors: Qingxuan YANG, Beijing (CN); Edward CHANG, Palo Alto, CA (US)

(21) Appl. No.: 14/722,754

(22) Filed: May 27, 2015

Related U.S. Application Data
(63) Continuation of application No. 14/387,012, now abandoned.

(51) Int. Cl. G01C 25/00; G01C 19/5783

(52) U.S. Cl. CPC G01C 25/005; G01C 19/5783

(57) ABSTRACT

A method and system for a non-intrusive parallel surface calibration for gyroscopes in a mobile device are described. In a mobile device having a gyroscope, multiple rotation matrices can be determined based on readings from the gyroscope. Each of these rotation matrices corresponds to a chain of rotations that occur when the mobile device is picked up from a surface and later placed down on any substantially parallel surface. In some instances, three or more rotation matrices can be determined. Calibration parameters can be computed from the rotation matrices and can be used to adjust subsequent readings from the gyroscope. An eigenvector can be determined for each of the rotation matrices and those eigenvectors can be used to obtain the calibration parameters through an optimization process. The gyroscope calibration can be triggered by a change in the temperature of the mobile device.

### CROSS-REFERENCE TO RELATED APPLICATIONS/INCORPORATION BY REFERENCE

Not Applicable.

### FIELD

Certain embodiments of the disclosure relate to the gyroscope calibration. More specifically, certain embodiments of the disclosure relate to a method and system for a non-intrusive parallel surface calibration for gyroscopes in a mobile device.

### BACKGROUND

Changes in temperature may affect a gyroscope's signal error characteristics. For mobile devices having gyroscopes, the temperature changes that occur as a user travels between indoor and outdoor locations may result in a need to calibrate the gyroscope. In some instances, gyroscope calibration may need to be performed often. Traditional gyroscope calibration methods for mobile device are carried out on complex and expensive calibration machines or by asking the user to perform certain specific motions with the mobile device according to a predetermined script. The former method can be impractical while the latter method is generally found to be intrusive and not a very good user experience.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and/or method are provided in which, in a mobile device comprising a gyroscope, multiple rotation matrices are determined based on outputs produced by the gyroscope, each of the rotation matrices corresponding to a chain of rotations that occur when the mobile device is picked up from a first surface and placed down on a second surface substantially parallel to the first surface. One or more calibration parameters are determined based on the rotation matrices. Subsequent outputs produced by the gyroscope are adjusted based on the one or more calibration parameters.

These and other advantages, aspects and novel features of the present disclosure, as well as details of illustrated embodiments thereof, will be more fully understood from the following description and drawings.

### BRIEF DESCRIPTION OF THE DRAWINGS

FIGS. 1A and 1B are each a diagram that illustrates rotations of a mobile device that result from user actions.

FIG. 2 is a diagram that illustrates the rotations that occur when a mobile device is picked up and placed down on parallel surfaces multiple times.

FIG. 3 is a block diagram that illustrates an example of a mobile device architecture.

FIG. 4 is a flow chart that illustrates examples of steps related to user actions with a mobile device.

FIG. 5 is a flow chart that illustrates examples of steps for a non-intrusive calibration of a gyroscope in a mobile device.

FIG. 6 is a flow chart that illustrates examples of steps for the computation of calibration parameters.

FIG. 7 is a flow chart that illustrates other examples of steps for a non-intrusive calibration of a gyroscope in a mobile device.

### DETAILED DESCRIPTION

Certain embodiments of the disclosure may be found in a method and system for a non-intrusive parallel surface calibration for gyroscopes in a mobile device. Various embodiments of the disclosure provide for determining multiple rotation matrices based on readings from a gyroscope in a mobile device. Each of these rotation matrices corresponds to a chain of rotations that occur when the mobile device is picked up from a surface and later placed down on any substantially parallel surface. In some instances, three or more rotation matrices can be determined. Calibration parameters, such as scaling factors, for example, can be computed from the rotation matrices and can be used to adjust subsequent readings from the gyroscope. An eigenvector can be determined or computed for each of the rotation matrices and those eigenvectors can then be used to obtain the calibration parameters through an optimization process. The gyroscope calibration can be triggered by a change in the temperature of the mobile device.

To perform a non-intrusive calibration of a gyroscope in a mobile device, one aspect to consider is that a mobile device is not in motion all of the time. For example, a mobile device is at times rested or placed on a desk, a charging station, or some other flat surface. These surfaces are typically parallel or substantially parallel to each other. Any time a mobile device is placed on a flat surface, the mobile device likely went through a series or chain of rotations between the time it was picked up by a user and the time it was placed on the flat surface. The rotations in the chain of rotations can be characterized or represented by a rotation matrix or by a rotation vector. This rotation matrix has a corresponding rotation axis that is perpendicular or normal to the flat surface on which the mobile device is rested. For a given rotation matrix, the rotation axis of that rotation matrix is the eigenvector or characteristic vector of that rotation matrix.

The mobile device can be picked up from a flat surface and placed back down on the same or other flat surface multiple times. It is therefore possible to obtain a rotation matrix, and a corresponding eigenvector, for each of these instances. Since the surfaces are parallel or substantially parallel to each other, the eigenvectors for each of the rotation matrices are expected to be the same or substantially the same. Any discrepancies between eigenvectors can be attributed to the noise characteristics of the gyroscope in the mobile device. The effects of the noise characteristics can be at least partially compensated, offset, or removed by obtaining a set of parameters or factors that can transform or adjust the eigenvectors in such a manner that they are all the same or substantially the same. These parameters or factors can be used to calibrate future readings produced by the gyroscope.

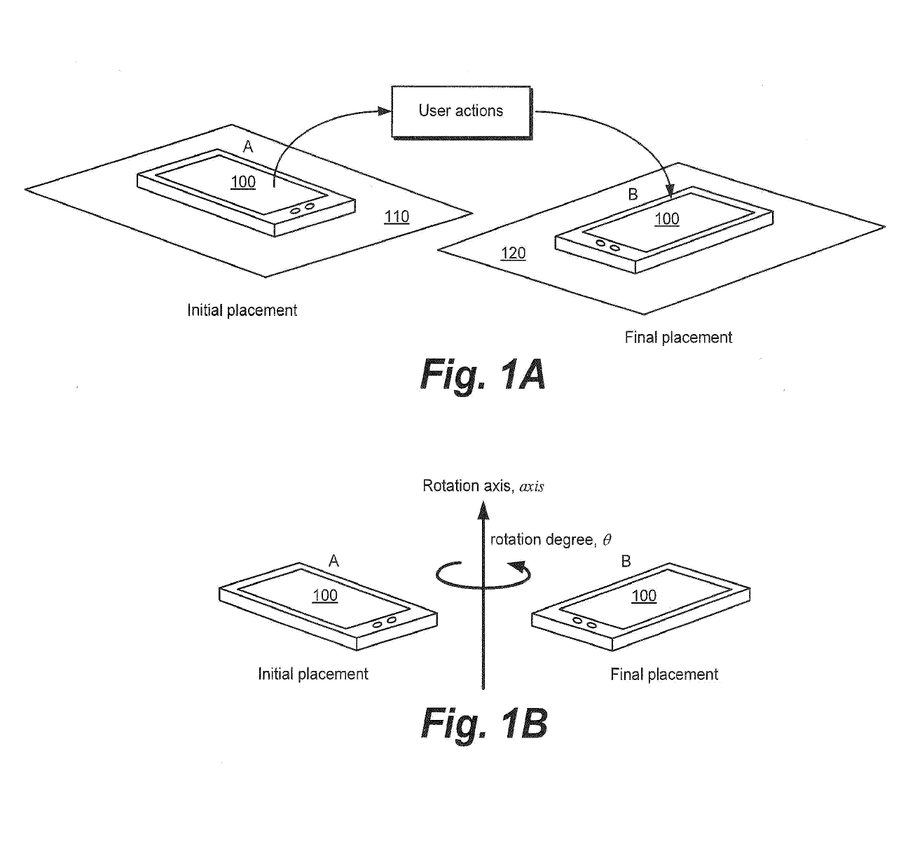

FIGS. 1A and 1B are each a diagram that illustrates rotations of a mobile device that result from user actions, in accordance with an embodiment. Referring to FIG. 1A, there is shown a mobile device 100 that is initially resting on a surface 110. The surface 110 can be the top of a desk or table, a charging station, or some other flat surface. When in its initial or reference placement on the surface 110, the mobile device 100 can have an attitude or orientation A, which indicates how the mobile device 110 is placed on the surface 110.

The mobile device 100 can be picked up by a user from its initial placement on the surface 110 and be subsequently placed down on a surface 120. The surface 120 can also be the top of a desk or table, a charging station, or some other flat surface. The surface 120 is parallel or substantially parallel to the surface 110. In some instances, the surface 120 can be the same as the surface 110. When in its final placement on the surface 120, the mobile device 100 can have an attitude or orientation B, which indicates how the mobile device 110 is place on the surface 110. The orientation of the mobile device 100 when in its final placement (B) can be different from the orientation when in its initial or reference placement (A).

The user can pick up the mobile device 100 from the surface 110 to perform any one of a variety of activities before placing the mobile device 100 back down on the surface 120. For example, the user can pick up the mobile device 100 to place a call, browse the web, run an application, send a message, play games, get directions or instructions, take pictures, or watch videos. These examples are illustrative of some of the activities that can be performed by a user with the mobile device 100. Whichever activity the user chooses to perform with the mobile device 100, and even when no action is taken beyond moving the mobile device 100, there are typically a number of rotations to the mobile device 100 that occur in connection with the user's actions or movements. This series or sequence of rotations can be referred to as a chain of rotations or a rotation chain. The chain of rotations that can occur when moving the mobile device 100 from its initial placement to its final placement can be represented by a single rotation about a fixed axis.

Referring to FIG. 1B, there is shown a rotation axis, axis, and a rotation degree, θ, which represent the chain of rotations that occur when moving the mobile device 100 from its orientation A on the surface 110 to its orientation B on the surface 120. The rotation axis and the rotation degree are equivalent to using a single rotation about a fixed axis to represent the chain of rotations. Additional aspects regarding the relationship between the attitude or orientation and rotations of the mobile device 100 are provided below.

The attitude or orientation of the mobile device 100 can be represented by an orientation matrix, M. In this regard, the orientation matrix can be related to a rotation vector for an absolute coordinate system, vₐ, and to a rotation vector for a relative coordinate system, vᵣ, by the following expression:

vₐ=M×vᵣ, (1)

where the orientation matrix describes the attitude or orientation of vᵣ with respect to vₐ. The orientation matrix can be used to represent a current orientation of the mobile device 100.

A rotation, such as the rotation of the mobile device 100 from its orientation A on the surface 110 to its orientation B on the surface 120, can be represented by a rotation vector, vectorᵣₒₜₐₜᵢₒₙ, which is itself represented by the rotation axis and the rotation degree shown in FIG. 1B. The rotation axis and the rotation degree can be respectively described by the following expressions:

axis=(x,y,z), (2)

and

deg=θ. (3)

Based on equations (2) and (3) above, the rotation vector can be determined from the following expression:

vectorᵣₒₜₐₜᵢₒₙ=(θx,θy,θz). (4)

In addition to the use of a rotation vector, a rotation can also be represented by a rotation matrix, Mᵣₒₜₐₜᵢₒₙ. Because the rotation axis and the rotation degree are known from equations (2) and (3), and because the rotation axis is a unit vector and |axis|=1, the rotation matrix can be determined from the following expression:

$${M}_{rotation} = [ \begin{matrix}cos ( c ) + x ( 1 - cos ( c ) ) & xy ( 1 - cos ( c ) ) - z sin ( c ) & xz ( 1 - cos ( c ) ) + y sin ( c ) \\ xy ( 1 - cos ( c ) ) + z sin ( c ) & cos ( c ) + y ( 1 - cos ( c ) ) & zy ( 1 - cos ( c ) ) - x sin ( c ) \\ xy ( 1 - cos ( c ) ) - y sin ( c ) & zy ( 1 - cos ( c ) ) + x sin ( c ) & cos ( c ) + y ( 1 - cos ( c ) )\end{matrix} ] , \qquad ( 5 )$$

where c is the rotation degree or θ.

Conversely, the rotation axis can be determined from the rotation matrix based on the following expression:

axis=Eigenvector(Mᵣₒₜₐₜᵢₒₙ). (6)

In other words, the rotation axis shown in FIG. 1B corresponds to the eigenvector or characteristic vector of the rotation matrix that represents the chain of rotations that occur when the mobile device 100 is moved from its orientation A on the surface 110 to its orientation B on the surface 120.

Because the determination of the rotation vector, the rotation matrix, and/or the eigenvector of the rotation matrix are based on the actions that take place between the initial resting on the surface 110 and the final resting on the surface 120, the mobile device 100 can be operable to determine when it was placed on the surface 110 and when it was placed on the surface 120.

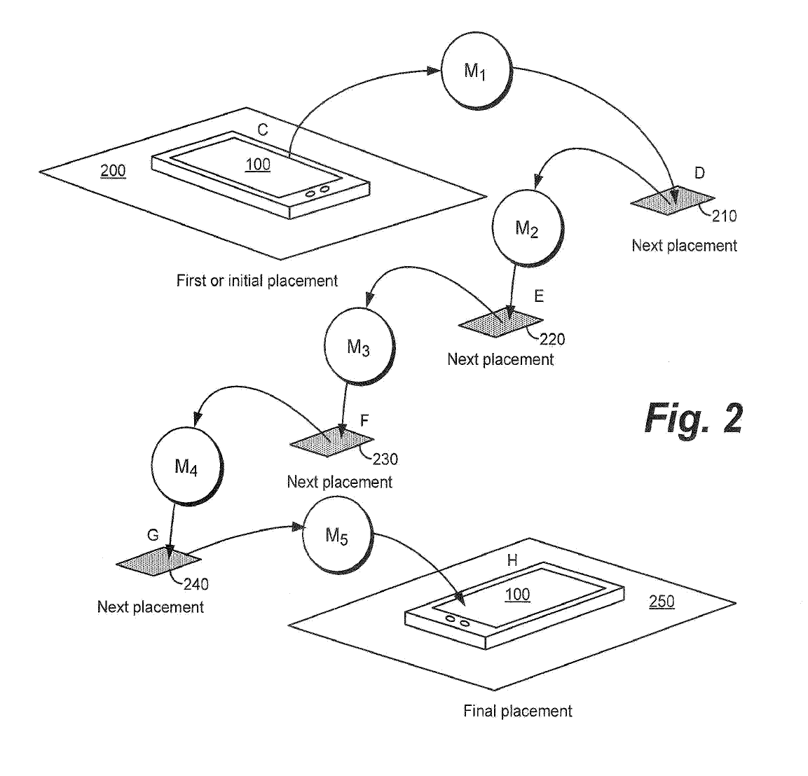

FIG. 2 is a diagram that illustrates the rotations that occur when a mobile device is picked up and placed down on parallel surfaces multiple times, in accordance with an embodiment. Referring to FIG. 2, there is shown the mobile device 100 at an initial or reference placement on a surface 200 and having an orientation C. A user can pick up the mobile device 100 and place it down on a surface 210 after some activity. The surface 210 can be a flat surface that is parallel or substantially parallel to the surface 200. When placed on the surface 210, the mobile device 100 can have an orientation D.

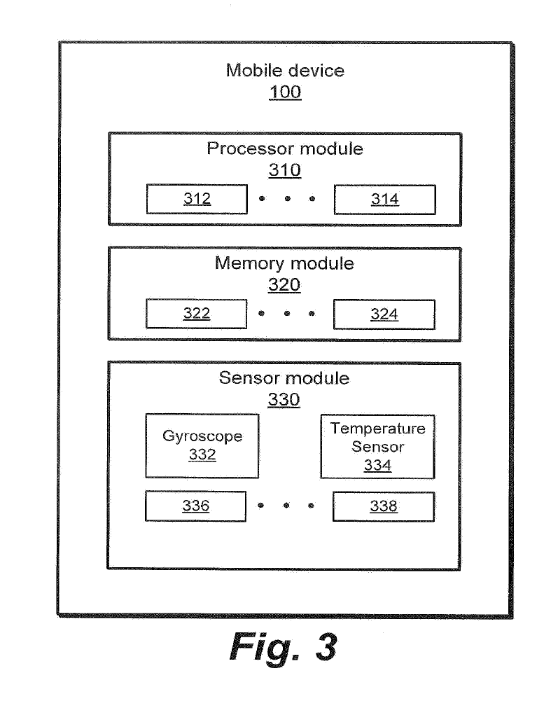

A first rotation matrix, M₁, can be used to represent or characterize the chain of rotations that occur between the mobile device 100 being picked up from the surface 200 and subsequently being placed down on the surface 210. To determine the first rotation matrix, the mobile device 100 can be operable to determine when it was placed on the surface 200 and when it was placed on the surface 210. For example, the mobile device 100 can determine that at a time T₁ it was placed down on the surface 200 and that at a time T₂ it was placed down on the surface 210. The mobile device 100 can include a gyroscope (such as gyroscope 332, FIG. 3) and the signals or readings produced by the gyroscope between the times T₁ and T₂ can be collected to determine the first rotation matrix.

The same user or another user can pick up the mobile device 100 from the surface 210 and place it down on a surface 220 after some activity. The surface 220 can be a flat surface that is parallel or substantially parallel to the surface 200. When placed on the surface 220, the mobile device 100 can have an orientation E.

A second rotation matrix, M₂, can be used to represent or characterize the chain of rotations that occur between the mobile device 100 being picked up from the surface 210 and subsequently being placed down on the surface 220. To determine the second rotation matrix, the mobile device 100 can be operable to determine when it was placed on the surface 2100 and when it was placed on the surface 220. For example, the mobile device 100 can determine that at the time T₂ it was placed down on the surface 210 and that at a time T₃ it was placed down on the surface 220. Readings from the gyroscope in the mobile device 100 produced between the times T₂ and T₃ can be collected to determine the second rotation matrix.

A similar approach as described above can be used to determine a third rotation matrix, M₃, a fourth rotation matrix, M₄, and a fifth rotation matrix, M₅. For the third rotation matrix, the mobile device 100 can be picked up from the surface 220 and can be placed down on a surface 230 with an orientation F after some user activity. The mobile device 100 can determine that at the time T₃ it was placed down on the surface 220 and that at a time T₄ it was placed down on the surface 230. Readings from the gyroscope in the mobile device 100 produced between the times T₃ and T₄ can be collected to determine the third rotation matrix.

For the fourth rotation matrix, the mobile device 100 can be picked up from the surface 230 and can be placed down on a surface 240 with an orientation G after some user activity. The mobile device 100 can determine that at the time T₄ it was placed down on the surface 230 and that at a time T₅ it was placed down on the surface 240. Readings from the gyroscope in the mobile device 100 produced between the times T₄ and T₅ can be collected to determine the fourth rotation matrix.

For the fifth rotation matrix, the mobile device 100 can be picked up from the surface 240 and can be placed down on a surface 250 with an orientation H after some user activity. The mobile device 100 can determine that at the time T₅ it was placed down on the surface 240 and that at a time T₆ it was placed down on the surface 250. Readings from the gyroscope in the mobile device 100 produced between the times T₅ and T₆ can be collected to determine the fourth rotation matrix.

The surfaces 230, 240, and 250 described above can be flat surfaces that are parallel or substantially parallel to the surface 200. Moreover, the various orientations described above with respect to FIG. 2 can be different from each other and are merely provided to illustrate that a change in orientation can result from the chain of rotations that occur when the mobile device 100 is picked up from a flat surface and subsequently placed down on a parallel or substantially parallel surface.

The rotation matrices can be determined by the mobile device 100 in response to a trigger or some other internal signal that indicates that a calibration process for the gyroscope is to take place. As described above, a gyroscope calibration can be initiated when a temperature of the mobile device 100 increases or decreases by a certain, pre-determined amount. For example, an increase or decrease of 2° C., 3° C., 5° C., 7° C., 10° C., 15° C., or 20° C. can prompt the mobile device 100 to initiate a gyroscope calibration process. Once an indication exists that a calibration process is to be initiated, the mobile device 100 can be operable to collect and process the appropriate information and/or readings (e.g., gyroscope readings, temperature readings) to determine the rotation matrices that are going to be used to compute a current set of calibration parameters.

When the current round of calibration is complete, the mobile device 100 can begin to collect and process the appropriate information and/or readings to determine the next set of rotation matrices that are going to be used to compute the next set of calibration parameters.

While five (5) rotation matrices are illustrated in FIG. 2, a gyroscope calibration process can use more or fewer rotation matrices to compute the calibration parameters.

FIG. 3 is a block diagram that illustrates an example of a mobile device architecture, in accordance with an embodiment. Referring to FIG. 3, there is shown the mobile device 100 having a processor module 310, a memory module 320, and a sensor module 330.

The sensor module 330 can have a gyroscope 332, a temperature sensor 334, and other sensing devices 336, . . . , 338. Each of these devices can be a separate integrated circuit (IC), although two or more of these devices can be included in the same IC. The gyroscope 332 can be operable to generate or produce outputs (e.g., readings, signals) that provide motion information of the mobile device 100. The motion information can include, but need not be limited to, rotation information. The gyroscope 332 can provide three-dimensional motion information of the mobile device 100. In some embodiments of the disclosure, more than one gyroscope can be used, where each of the gyroscopes provides motion information for a particular dimension. When the mobile device 100 is in a static or stationary position, such as when it is placed on a flat surface, the outputs from the gyroscope 332 can include a bias reading. The temperature sensor 334 can be operable to generate or produce outputs (e.g., readings, signals) that provide temperature information of the mobile device 100.

The sensor devices 336, . . . , 338 can include other sensors such as accelerometers, for example. The sensor devices 336, . . . , 338 can be operable to detect whether the mobile device 100 is in a static or stationary position, such as when the mobile device 100 is placed on a flat surface. In this regard, the sensing devices 336, . . . , 338 can be operable to generate or produce outputs (e.g., readings, signals) that indicate when the mobile device 100 is placed in a static or stationary position.

The processor module 310 can have multiple ICs 312, . . . , 314 that can be operable to perform data processing. The ICs 312 can include a central processing unit (CPUs), a digital signal processor (DSP), and/or other processing hardware devices. The processor module 310 can also include an operating system, firmware, and/or other suitable software, code, or application that allow the ICs 312, . . . , 314 to perform data processing and/or computations for the calibration of the gyroscope 332. For example, the ICs 312, . . . , 314 can be operable to collect and process readings from the gyroscope 332, collect and process readings from the temperature sensor 334, collect and process readings from the sensor devices 336, . . . , 338, determine rotation matrices, determine rotation vectors, determine eigenvectors, perform optimization operations, determine calibration parameters, and/or adjust readings from the gyroscope 332.

The memory module 320 can have multiple ICs 322, . . . , 324 that can be operable to store data, including data for the calibration of the gyroscope 332. For example, the ICs 322, . . . , 324 can be operable to store readings from the gyroscope 332, readings from the temperature sensor 334, readings from the sensor devices 336, . . . , 338, data generated from the determination of rotation matrices, data generated from the determination of rotation vectors, data generated from the determination of eigenvectors, data generated from optimization operations, calibration parameters, and/or to adjusted readings from the gyroscope 332.

Each of the processor module 310, the memory module 320, and the sensor module 330 includes suitable logic, circuitry, code, and/or interfaces to communicate data or other information within themselves and with each other.

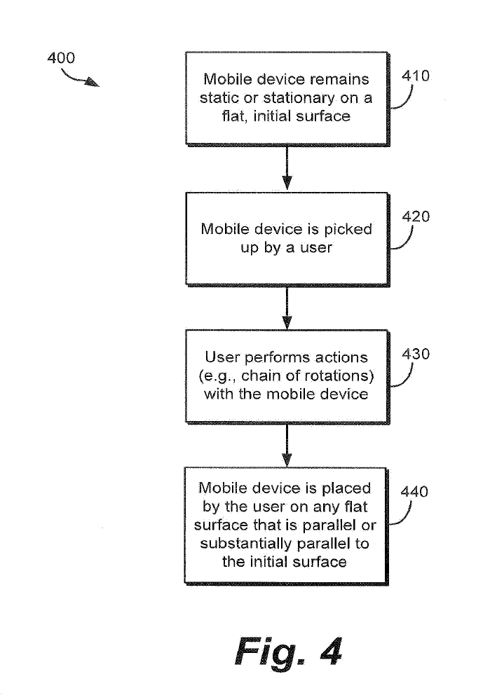

FIG. 4 is a flow chart that illustrates examples of steps related to user actions with a mobile device, in accordance with an embodiment. Referring to FIG. 4, there is shown a flow chart 400 that describes the placement of a mobile device, such as the mobile device 100, on multiple parallel surfaces as illustrated in the example described above with respect to FIG. 1A. At step 410, the mobile device 100 can remain static or stationary on a flat, initial surface after being placed down on that surface by a user. The mobile device 100 can determine that it is in a static position based on readings provided by sensors in the sensor module 330. When the mobile device 100 is to perform a calibration of the gyroscope 332, the placing down of the mobile device 100 on the initial surface can start the collection of the readings produced by the gyroscope 332. While those readings can be collected when the mobile device 100 is still static, the readings collected will reflect that no rotations are yet taking place. Bias readings produced by the gyroscope 332 can be obtained when the mobile device 100 is static. The bias readings can be stored in the memory module 320. The calibration of the gyroscope 332 can be initiated from a change in temperature in the mobile device 100 that is detected by the temperature sensor 334.

At step 420, the mobile device 100 is picked up by a user to perform certain actions. At step 430, the user performs those actions and the mobile device 100 moves accordingly. The sequence or chain of rotations that occur in connection with the motions of the mobile device 100 can be detected by the gyroscope 332. In this regard, the gyroscope 332 can generate readings of those rotations and those readings can be stored in the memory module 320 for later use in the computation of a rotation matrix corresponding to the chain of rotations in step 430.

At step 440, the user can place the mobile phone 100 down on any flat surface that is parallel or substantially parallel to the initial surface in step 410. In some instances, the flat surface in step 440 can be the same flat surface as in step 410. At this point, the mobile phone 100 can detect that it is in a static or stationary position and can complete the collection of gyroscope readings for use in the computation of the rotation matrix corresponding to the chain of rotations in step 430. The mobile device 100 can determine that it is in a static position based on readings provided by sensors in the sensor module 330.

FIG. 4 describes a single set of actions and, consequently, a single chain of rotations, with the mobile device 100 to produce one rotation matrix as illustrated in FIG. 2. Nevertheless, additional sets of actions can be performed and their corresponding rotation matrices can be determined in a similar manner to obtain a sufficient number of rotation matrices to determine the calibration parameters for the gyroscope 332.

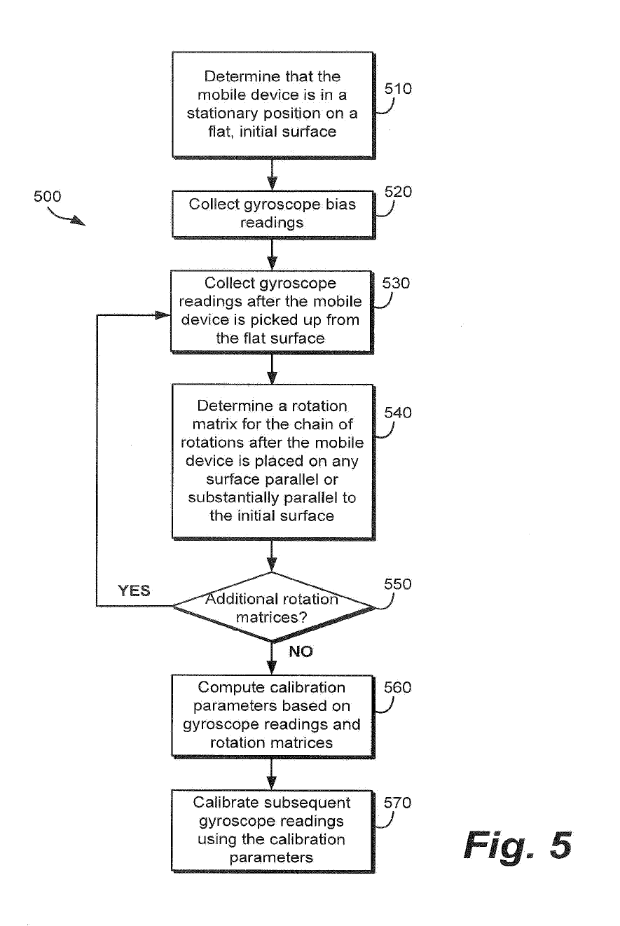

FIG. 5 is a flow chart that illustrates examples of steps for a non-intrusive calibration of a gyroscope in a mobile device, in accordance with an embodiment. Referring to FIG. 5, there is shown a flow chart 500 that describes the placement of a mobile device, such as the mobile device 100, on multiple parallel surfaces as illustrated in the example described above with respect to FIG. 2. At step 510, the mobile device 100 can remain static or stationary on a flat, initial surface after being placed down on that surface by a user. The mobile device 100 can determine that it is in a static position based on readings provided by sensors in the sensor module 330.

At step 520, when the mobile device 100 is to perform a calibration of the gyroscope 332, the placing down of the mobile device 100 on the initial surface can start the collection of the readings produced by the gyroscope 332. The calibration of the gyroscope 332 can be initiated from a change in temperature in the mobile device 100 that is detected by the temperature sensor 334. While those readings can be collected when the mobile device 100 is still static, the readings collected will reflect that no rotations are yet taking place. Bias readings produced by the gyroscope 332, however, can be obtained when the mobile device 100 is static. The bias readings can be stored in the memory module 320.

At step 530, the mobile device 100 is picked up by a user to perform certain actions. The sequence or chain of rotations that occur in connection with the motions of the mobile device 100 that result from the user's actions can be detected by the gyroscope 332. The readings produced by the gyroscope 332 can be collected and stored in the memory module 320.

At step 540, after the user places the mobile phone 100 down on any flat surface that is parallel or substantially parallel to the initial surface in step 510, the mobile phone 100 can detect that it is in a static or stationary position and can complete the collection of gyroscope readings. The mobile device 100 can determine that it is in a static position based on readings provided by sensors in the sensor module 330. The processor module 310 in the mobile device 100 can be used to obtain the collected readings from the memory module 320 and to determine a current rotation matrix corresponding to the chain of rotations taking place before the mobile device 100 was last placed down on a flat surface.

At step 550, the mobile device 100 can determine whether additional rotation matrices are needed to compute the calibration parameters for the gyroscope 332. When additional rotation matrices are needed, the process can return to step 530 where a new set of gyroscope readings can be collected when the mobile phone 100 is picked up again by a user. When no additional rotation matrices are needed, the process can proceed to step 560. While three or more rotation matrices can be sufficient to generate the calibration parameters, at least five rotation matrices can be typically used to generate the calibration parameters.

At step 560, the processor module 310 can determine the calibration parameters based on gyroscope readings, including bias readings, and the rotation matrices. The calibration parameters can be determined by using a parallel surface calibration algorithm that is described in more detail below. The calibration parameters can be stored in the memory module 320 and can be associated with the temperature reading that triggered or initiated the gyroscope calibration process. At step 570, subsequent gyroscope readings can be calibrated by using the calibration parameters stored in the memory module 320. For example, when the calibration parameters are scaling factors, the readings produce by the gyroscope 332 can be multiplied by the appropriate scaling factor for calibration.

As noted above, the rotation matrices used in the gyroscope calibration process can trace the attitude or orientation of the mobile device 100 as it is rotated through a chain of rotations. When the mobile device 100 is rotated by some amount or degree, the following expression can be used to determine the new attitude (orientation matrix) of the mobile device 100:

M_{new}=M_{old}×Mᵣₒₜₐₜᵢₒₙ, (7)

where M_{old} is the previous orientation matrix of the mobile device 100, M_{new} is the new orientation matrix, and Mᵣₒₜₐₜᵢₒₙ is the rotation matrix that characterizes the amount or degree of rotation that took place.

Readings from the gyroscope 332 are typically provided in angular velocity vector format as shown in the following expression:

reading_{gyroscope}=(ωx,ωy,ωz). (8)

The readings from the gyroscope 332 can be used to calculate the rotation axis and the rotation degree described above with respect to FIG. 1B. For example, the rotation axis and the rotation degree can be obtained from the following expressions:

$$\begin{matrix}axis = ( x , y , z ) = \frac{{reading}_{gyroscope}}{\vert {reading}_{gyroscope} \vert} , \\ and & ( 9 ) \\ deg = ωΔ t = \vert {reading}_{gyroscope} \vert Δ t , & ( 10 )\end{matrix}$$

where Δt represents an incremental time corresponding to the readings of the gyroscope 332. Thus, the attitude at the start of a chain of rotations, Mₛₜₐᵣₜ, and the attitude at the end of a chain of rotations, M_{end}, are related by the following expression:

$${M}_{end} = {M}_{start} \times {\prod }_{start}^{end} Matrix ( axis , ω Δ t ) = {M}_{start} \times {M}_{rotation} . \qquad ( 11 )$$

Even when the readings from the gyroscope 332 are provided in angular velocity vector format, those readings can be used to calculate the orientation of the mobile device 100 by using the expressions in equations (9), (10), and (11).

The gyroscope 332 is typically an IC that is positioned within the mobile device 100 such that the back cover of the mobile device 100 is parallel to the surface of the gyroscope 332. That is, when the mobile device 100 is placed on a flat surface, the rotation axis of the mobile device 100 is the same as the coordinate that is normal to the surface of the IC having the gyroscope 332. Accordingly, the readings from the gyroscope 332 when the mobile device 100 is placed on flat surfaces (e.g., start surface, end surface) are expected to produce the same rotation axis as illustrated by the following expression:

$$Eigenvector ( {\prod }_{start}^{end} Matrix ( axis , ωΔ t ) ) = X , \qquad ( 12 )$$

Where X is the identical vector and the modulus of X is equal to 1. Because X is the identical vector, all chains of rotations that take place when the mobile device 100 is picked up and placed down multiple times are to produce the same rotation axis or same eigenvector. Any discrepancies between eigenvectors can be attributed to the noise characteristics of the gyroscope 332 in the mobile device 100 and need to be corrected by a gyroscope calibration process.

The noise or error signals of the gyroscope 332 can be described by some parameters. The parallel surface calibration algorithm includes the calculation of the parameters that correspond to the noise or error signals of the gyroscope 332 and then using those parameters to calibrate subsequent or future outputs (e.g., readings, signals) from the gyroscope 332.

One approach is to use a linear error model to represent the errors in the readings from the gyroscope 332. The linear error model uses the following expressions:

(xᵥₐₗᵤₑ,yᵥₐₗᵤₑ,zᵥₐₗᵤₑ)=a, (13)

(x_{reading},y_{reading},z_{reading})=r, (14)

and

(x_{scale},y_{scale},z_{scale})=f, (15)

where a is the true value of the rotation speed vector, r is the reading from the gyroscope 332, and f represents the linear factors or scaling factors. The linear model can be described by the following expression:

a=((r−b)∘f), (16)

where b is a bias reading from the gyroscope 332, and the operator ∘ denotes a Hadamard product, which takes two vectors with the same dimensions and produces another vector where each element ij is the product of the elements ij of the original two vectors. The bias from the gyroscope 332 can be obtained when the mobile device 100 is in a static or stationary position and can be subtracted in real time. The remaining parameters from the linear error model that are needed are the scaling factors, f.

The rotation matrix and the eigenvector of Δt can be described by the following expressions:

$$\begin{matrix}Matrix ( axis , ωΔ t ) = Matrix ( a Δ t ) = Matrix ( ( r - b ) ∘ f ) , \\ and & ( 17 ) \\ Eigenvector ( {\prod }_{start}^{end} Matrix ( ( r - b ) ∘ f ) ) = u . & ( 18 )\end{matrix}$$

Accordingly, for each chain of rotations that occur when the mobile device 100 is picked up and placed down on a flat surface multiple times, the eigenvector is described by the following expression:

$$Eigenvector ( {\prod }_{{start}_{i}}^{{end}_{i}} Matrix ( ( r - b ) ∘ f ) ) = {u}_{i} . \qquad ( 19 )$$

Because X is the identical vector as noted above with respect to equation (12), then each uᵢ is expected to be the same unless they differ as a result of the noise or error characteristics of the gyroscope 332. An average axis vector can be defined by the following expression:

$$\overline{u} = \frac{1}{n} {\sum }_{i = 1}^{n} {u}_{i} . \qquad ( 20 )$$

To minimize the variance, the following sequence of expressions can be used:

$$\begin{matrix}u = {\sum }_{i = 1}^{n} ( ( {u}_{i} - \overline{u} ) {( {u}_{i} - \overline{u} )}^{T} ) , & ( 21 ) \\ q = {\sum }_{i = 1}^{n} {u}_{i} {u}_{i}^{T} - {\sum }_{i = 1}^{n} {u}_{i} {\overline{u}}_{i}^{T} - {\sum }_{i = 1}^{n} \overline{u} {u}_{i}^{T} + n \overline{u} {\overline{u}}^{T} , \\ and & ( 22 ) \\ {\sum }_{i = 1}^{n} {u}_{i} = n \overline{u} , & ( 23 )\end{matrix}$$

where equation (23) results from equation (20).

Because uᵢ is a unit vector, then uᵢuᵢ^{T} equals to 1. These results, and equation (23), allow the simplification of equation (22) as described by the following expression:

q=n−n u̅u̅^{T}=n(1−|ū|²). (24)

To minimize the variance |ū| is to be maximized or

$$\vert {\sum }_{i = 1}^{n} {u}_{i} \vert$$

is to be maximized. The optimization operation now includes finding the appropriate scaling factors that maximize

$$\vert {\sum }_{i = 1}^{n} {u}_{i} \vert .$$

Various methods can be used to solve the optimization operation. For example, the processor module 310 can be used to perform a downhill-simplex optimization method to determine the scaling factors or scaling parameters. These parameters, once determined, can be stored in the memory module 320 and can be used as calibration parameters to adjust future readings from the gyroscope 332.

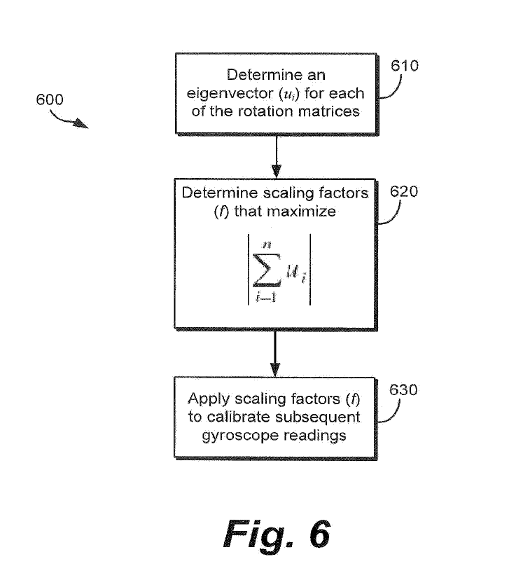

FIG. 6 is a flow chart that illustrates examples of steps for the computation of calibration parameters, in accordance with an embodiment. Referring to FIG. 6, there is shown a flow chart 600 in which, at step 610, the processor module 310 in the mobile device 100 can determine an eigenvector, uᵢ, for each of the rotation matrices that are to be used for computing the calibration parameters. While three or more rotation matrices and corresponding eigenvectors can be used, a typical gyroscope calibration process can use at least five rotation matrices and corresponding eigenvectors. The processor module 310 can be operable to perform the calculations corresponding to equations (18) or (19), for example, to obtain the eigenvectors.

At step 620, the processor module 310 can determine the scaling factors that minimize the eigenvector variance. The eigenvector variance can be minimized by maximizing

$$\vert {\sum }_{i = 1}^{n} {u}_{i} \vert ,$$

where each of the eigenvectors was determined in step 610. The processor module 310 can obtain the scaling factors by performing an optimization operation to maximize the eigenvector variance, such as the downhill-simplex optimization method, for example. Once obtained, the scaling factors can be stored in the memory module 320. At step 630, the scaling factors can be used as calibration parameters to calibrate subsequent or future outputs (e.g., readings, signals) from the gyroscope 332.

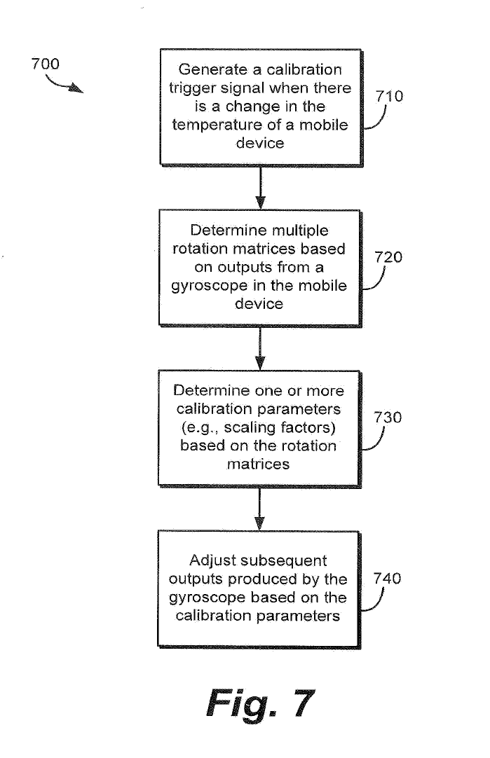

FIG. 7 is a flow chart that illustrates other examples of steps for a non-intrusive calibration of a gyroscope in a mobile device, in accordance with an embodiment. Referring to FIG. 7, there is shown a flow chart 700 in which, at step 710, the processor module 310 can generate a calibration trigger signal in response to a change in temperature of the mobile device 100. The change in temperature can be detected from readings provided by the temperature sensor 334 and processed by the processor module 310. For example, an increase or decrease of 2° C., 3° C., 5° C., 7° C., 10° C., 15° C., or 20° C. can prompt the mobile device 100 to initiate a gyroscope calibration process. These changes in temperature are provided by way of illustration and not of limitation. Other threshold values can be used as changes in temperature that can prompt the mobile device 100 to initiate a gyroscope calibration process.

At step 720, the processor module 310 can determine multiple rotation matrices based on outputs from the gyroscope 332. The outputs can include rotation speed vector readings and bias readings, for example. At step 730, the processor module 310 can determine one or more calibration parameters, such as scaling factors, for example, based on the rotation matrices. In this regard, the processor module 310 can compute eigenvectors from the rotation matrices and use the eigenvectors in an optimization process to obtain the calibration parameters. At step 740, the calibration parameters can be used to adjust subsequent or future outputs (e.g., readings, signals) from the gyroscope 332.

In an embodiment of the disclosure, the mobile device 100 with the gyroscope 332 can determine more than one rotation matrix based on outputs or readings produced by the gyroscope 332. Each of rotation matrices corresponds to a chain of rotations that occur when the mobile device 100 is picked up from a first surface and placed down on a second surface that is substantially parallel to the first surface. In some instances, the first and second surfaces can be the same surface. While the number of rotation matrices that are determined by the mobile device 100 for calibration of the gyroscope 332 can be three or more, using at least five rotation matrices can be a typical approach.

The mobile device 100 can determine one or more calibration parameters (e.g., scaling factors) based on the rotation matrices. The mobile device 100 may then adjust subsequent outputs or readings produced by the gyroscope 332 based on the calibration parameters. Once determined, the calibration parameters can be stored in the memory module 320.

In another aspect of this embodiment of the disclosure, the mobile device 100 can initiate a calibration process for the gyroscope 332 in response to changes in temperature. For example, the mobile device 100 can determine the rotation matrices after a temperature corresponding to the mobile device 100 changes by an amount larger than a threshold amount. The temperature sensor 334 can produce a reading of the temperature used by the mobile device 100 to initiate the calibration of the gyroscope 332. Moreover, the temperature reading or value that prompted the start of the calibration process can be stored in the memory module 320, where it can be associated with the calibration parameters.

In yet another aspect of this embodiment of the disclosure, the mobile device 100 can determine an eigenvector or a characteristic vector for each of the rotation matrices and can determine the calibration parameters based on an optimization of the eigenvectors. To determine the eigenvectors, a bias reading made by the gyroscope 332 when the mobile device 100 is in a stationary position (e.g., resting on a flat surface) can be subtracted from the outputs or readings produced by the gyroscope 332 and used to determine the rotation matrices that correspond to the eigenvectors. The optimization can be based on a downhill-simplex method, for example. Other methods, however, can also be used for the optimization of the eigenvectors.

Another embodiment of the disclosure may provide a non-transitory machine and/or computer readable storage and/or media, having stored thereon, a machine code and/or a computer program having at least one code section executable by a machine and/or a computer, thereby causing the machine and/or computer to perform the steps as described herein for a non-intrusive parallel surface calibration of a gyroscope in a mobile device.

Accordingly, the present disclosure may be realized in hardware, software, or a combination of hardware and software. The present disclosure may be realized in a centralized fashion in at least one computer system; or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which includes all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A method, comprising:
in a mobile device comprising a gyroscope,
determining a plurality of rotation matrices based on outputs produced by the gyroscope, each of the plurality of rotation matrices corresponding to a chain of rotations that occur when the mobile device is picked up from a first surface and placed down on a second surface substantially parallel to the first surface;
determining one or more calibration parameters based on the plurality of rotation matrices; and
adjusting subsequent outputs produced by the gyroscope based on the one or more calibration parameters.

2. The method of claim 1, comprising determining the plurality of rotation matrices after a temperature corresponding to the mobile device changes by an amount larger than a threshold amount.

3. The method of claim 1, comprising:
determining a plurality of eigenvectors, each of which corresponds to one of the plurality of rotation matrices; and
determining the one or more calibration parameters based on an optimization of the plurality of eigenvectors.

4. The method of claim 3, comprising determining the plurality of eigenvectors by subtracting a bias from the outputs produced by the gyroscope, the bias being determined when the mobile device is in a stationary position.

5. The method of claim 1, comprising:
determining a plurality of eigenvectors, each of which corresponds to one of the plurality of rotation matrices; and
determining the one or more calibration parameters based on an optimization of the plurality of eigenvectors, the optimization being based on a downhill-simplex method.

6. The method of claim 1, wherein the first surface is the same as the second surface.

7. The method of claim 1, wherein the plurality of rotation matrices comprises three or more rotation matrices.

8. The method of claim 1, wherein the plurality of rotation matrices comprises at least five rotation matrices.

9. The method of claim 1, comprising storing the one or more calibration parameters and corresponding temperature of the mobile device.

10. The method of claim 1, wherein:
the gyroscope is comprised in an integrated circuit within the mobile device, and
a surface of the integrated circuit is substantially parallel to a back surface of the mobile device.

11. A mobile device, comprising:
one or more processors; and
a gyroscope,
wherein the one ore more processors are operable to determine a plurality of rotation matrices based on outputs produced by the gyroscope, each of the plurality of rotation matrices corresponding to a chain of rotations that occur when the mobile device is picked up from a first surface and placed down on a second surface substantially parallel to the first surface,
wherein the one or more processors are operable to determine one or more calibration parameters based on the plurality of rotation matrices, and
wherein the one or more processors are operable to adjust subsequent outputs produced by the gyroscope based on the one or more calibration parameters.

12. The mobile device of claim 11, wherein:
the mobile device comprises a temperature sensor, and
the one or more processors are operable to determine the plurality of rotation matrices after a temperature value produced by the temperature sensor changes by an amount larger than a threshold amount.

13. The mobile device of claim 11, wherein the one or more processors are operable to:
determine a plurality of eigenvectors, each of which corresponds to one of the plurality of rotation matrices, and
determine the one or more calibration parameters based on an optimization of the plurality of eigenvectors.

14. The mobile device of claim 13, wherein the one or more processors are operable to determine the plurality of eigenvectors by subtracting a bias from the outputs produced by the gyroscope, the bias being determined when the mobile device is in a stationary position.

15. The mobile device of claim 11, wherein the one or more processors are operable to:
determine a plurality of eigenvectors, each of which corresponds to one of the plurality of rotation matrices, and
determine the one or more calibration parameters based on an optimization of the plurality of eigenvectors, the optimization being based on a downhill-simplex method.

16. The mobile device of claim 11, wherein the first surface is the same as the second surface.

17. The mobile device of claim 11, wherein the plurality of rotation matrices comprises three or more rotation matrices.

18. The mobile device of claim 11, wherein:
the mobile device comprises a memory, and
the one or more processors are operable to store the one or more calibration parameters and corresponding temperature of the mobile device in the memory.

19. A mobile device, comprising:
one or more processors;
a gyroscope; and
a temperature sensor,
wherein the one or more processors are operable to determine a plurality of rotation matrices when a temperature value produced by the temperature sensor changes by an amount larger than a threshold amount, each of the plurality of rotation matrices corresponding a chain of rotations that occur between placements of the mobile device on parallel surfaces,
wherein the one or more processors are operable to determine one or more calibration parameters based on the plurality of rotation matrices, and
wherein the one or more processors are operable to adjust outputs produced by the gyroscope based on the one or more calibration parameters.
